(19) United States
(12) Patent Application Publication
(10) Pub. No.: US 2013/0176471 A1
(43) Pub. Date: Jul. 11, 2013

(54) CCD ACCUMULATING CHARGES OUTSIDE THE IMAGE FRAME

(71) Applicants: Todor Georgiev, Sunnyvale, CA (US); Elka Georgieva, Sunnyvale, CA (US)

(72) Inventors: Todor Georgiev, Sunnyvale, CA (US); Elka Georgieva, Sunnyvale, CA (US)

(21) Appl. No.: 13/733,202

(22) Filed: Jan. 3, 2013

Related U.S. Application Data
(60) Provisional application No. 61/583,183, filed on Jan. 5, 2012.

(51) Int. Cl. H04N 5/335

(52) U.S. Cl. CPC H04N 5/335
USPC 348/311; 348/294

(57) ABSTRACT

In one embodiment charges from the photodiodes in a CCD are interline-transferred to a vertical shift register; then they are transferred vertically to a second image frame, where they are interline-transferred to storage pixels in the second frame. Repeating this process one or more times leads to accumulation of charge in the storage pixels having full well capacity bigger than the original photodiodes. In another embodiment, charges from a CCD in the horizontal readout register are selectively transferred through a gate into a second horizontal register. From the second horizontal register charges are shifted vertically into vertical shift registers and then transferred into the storage pixels having big full well capacity. During readout time, in both cases charges are transferred to a horizontal shift register for readout as in a conventional CCD. In a plurality of embodiments this device can be used instead of a CCD with big pixels or binning, with the advantage that the photodiodes may be physically smaller in size compared to the size needed for storage of the full charge that is accumulated. This invention greatly extends the dynamic range that can be achieved with small pixels.

### BACKGROUND OF THE INVENTION

High end imagers based on charge coupled devices (CCDs) are widely used in scientific applications, including microscopy, astronomy, and others. They are also used in professional photography to capture low noise images with high dynamic range. What is common for these applications is the large full well capacity of a pixel in the CCD. This is made possible by the large size of the pixel, up to 24 microns on a side, which can hold up to a million electrons. At the same time, the noise level of the amplifier used to read out those pixels is on the order of 10 to 20 electrons. Examples can be found on the website of Kodak at http://www.kodak.com/ek/US/en/Image_Sens_Solutions/Products/Full_Frame_CCD.htm.

The noise level in a CCD is a combination of Shot noise, which is square root of the number of electrons, dark noise, and amplifier noise. With strong illumination the signal to noise ratio is a large number, proportional to the square root of the signal. Even for low illumination the signal to noise ratio is high due to the large pixels, which each collect lots of light. This results in low noise high dynamic range images in scientific and professional photography.

Often there is also a goal of achieving high magnification. This is the case in microscopy and in some astronomical applications. At the same time, photographers would benefit from more compact cameras. Increased magnification and more compact cameras are both enabled by reduced pixel size. Unfortunately, in all prior art applications, pixel size is directly related to dynamic range and signal to noise ratio.

This defines the problem solved by the current invention. Imaging with small pixels is desirable for the above applications. However, small pixels have small full well capacity. This results in low dynamic range, and low signal to noise ratio. With average capacity between 1000 and 8000 electrons, pixels of size one micron on a side have dynamic range 500 times less than what is expected from high end cameras. Also the signal to noise ratio is totally unacceptable. In the best case of strong illumination it is 30 times worse than with high end cameras, and at low illumination the noise is higher than the signal.

Multiple readouts of the sensor in order to capture multiple pictures and average them digitally is a very imperfect solution to the problem. At each readout of an image, noise is added by the amplifier, so that signal to noise ratio improves very slowly with increasing number of pictures. Also, taking multiple pictures is slow and there is a limit of how many pictures can be taken within a given total exposure time.

In this way, pixel size is coupled to dynamic range and to noise level. Imaging with pixels of size under one micron is practically useless even if such pixels can be manufactured and are completely functional. On the other hand, this is the range where optical microscopy also begins to fail due to diffraction. Direct imaging without lenses would resolve the diffraction problem of microscopy if the dynamic range and signal to noise ratio of small pixels could be improved. Similarly, better magnification in astronomy and other scientific applications would become possible. Also, compact cameras would be beneficial for professional photography.

FIG. 1 shows one conventional CCD imager. Referring to FIG. 1, the basic structure and functionality of a prior art Frame Interline Transfer CCD 100 is shown. The image capturing frame 101 consists of two types of pixels: Active, i.e. light sensitive pixels (photodiodes) 110, and shielded pixels 120. Shielded pixels in 101 are arranged into columns called vertical shift registers. Immediately below the image capturing frame 101 there is a storage frame comprising the same number of shielded pixels as in the vertical shift registers in 101. Those pixels are arranged in vertical shift registers of the storage frame. One such register is represented, and it comprises three pixels 130. This frame is used for temporary storage of the image. Immediately below the storage frame there is a row of pixels 140 forming the horizontal shift register. It contains the same number of pixels as in one row of the storage frame. Immediately to the left of it there is a mechanism used for readout, ending with a signal amplifier 150.

The functioning of the Frame Interline Transfer CCD can be presented as three steps. In the first step charges created in all photodiodes are simultaneously transferred to the shielded pixels, each photodiode transferring charge to the pixel immediately to the left of it, as represented by arrows. For example the charge in 110 is transferred to 120.

During the second step charges in the vertical shift registers of 101 are shifted down to the storage frame, all at the same time, as represented by arrows. For one example, the left register starting with 120 is shifted down to 130.

In the third step, charges are transferred from the storage frame down to the horizontal shift register 140, one line at a time, while the photodiodes are collecting light for the next picture. After each line transfer, a read out of the horizontal shift register 140 is performed: 140 is repeatedly shifted to the left, one pixel at a time, and after each shift, the leftmost pixel charge is converted to voltage and then processed for output by the amplifier 150. This process continues until all stored pixels are read out through the amplifier.

Binning functionality is often implemented in the prior art: In order to implement binning, in the third step charges are transferred to the horizontal shift register 140 consecutively two or more times without read out of the horizontal shift register. This results in accumulation of charges from two or more pixels in the same pixel of the horizontal shift register. Finally, read out is performed. Instead of one single pixel at a time, the output signal represents sum of two or more pixels at a time.

The processes described in the above steps with optional binning are prior art to this invention. By combining same or similar processes in different ways, based on a different CCD architecture, the current invention produces new useful results.

### SUMMARY OF THE INVENTION

It is therefore a principal object of the present invention to provide embodiments of a CCD with small pixels which at the same time have significantly higher dynamic range and low noise. In other words, the goal is to decouple pixel size from noise and dynamic range.

In one aspect of the present invention, small photodiodes collect charges proportional to the amount of light. Before reaching saturation those small charges are transferred into bigger pixels serving as buffers having large charge capacity. Those buffers or charge storage cells are of large size and may be fewer than the number of the light collecting photodiodes for the purpose of using less silicon. In different embodiments pixels may be partitioned into groups, like even/odd rows for example. Charges are transferred to the large capacity storage pixels. The process of transfer is repeated until significant amount of charge is collected in the big pixels. After reading from one group only, reading is switched to the other group. It is important that charge is not lost and that every charge storage pixel receives charges only from its own light capturing pixel before read out. In this way the size of the specific light-to-charge converting devices, like photodiodes, is decoupled from the dynamic range. With long exposure the small pixels in different embodiments of the inventive CCD produce images that are as good as images captured with big pixels.

In another aspect of the invention the imaging system may be viewed as a modified Frame Interline Transfer CCD, where the storage frame is replaced with an inverted Interline Transfer CCD. It is driven by electrical signals to operate in reverse fashion, i.e. accumulating charges—instead of outputting charges.

In other embodiments the proposed CCD is designed as a dual CCD made of one Frame Transfer or Frame Interline Transfer CCD, and one Interline Transfer CCD driven to operate so that it accepts a sequential line of charges and accumulates them into storage pixels instead of traditional sequential output of pixel charges to an amplifier for readout (i.e., in a manner reverse to traditional CCD operation). The line of incoming pixel charges may be controlled with a gate so that charges from only part of the photosensitive pixels are recorded. The selection of one part or another part may be controlled in software, contributing to great flexibility.

In yet another variation of this embodiment the storage CCD is implemented as two linear CCDs next to each other. The first one is filled consecutively with charges from the photosensitive pixels. Then it transfers those charges to the second linear CCD where charges are accumulated after a number of cycles. At the last step accumulated charges are read out from the second linear CCD in a conventional fashion.

The details will become apparent from the drawing and the descriptions. It should be obvious that those embodiments are only examples or aspects of the general idea of the invention, which has infinite number of possible embodiments and variations.

### BRIEF DESCRIPTION OF THE DRAWINGS

FIG. 1 shows a prior art Frame Interline Frame Transfer CCD.

FIG. 2 shows a first embodiment of the inventive CCD based on Frame Interline Transfer for capture, where storage is implemented as interline CCD.

FIG. 3 shows an embodiment of the invention where only half of the lines in the image frame are stored during the first pass, and the other half are stored during a second pass of the capturing process.

FIG. 4 shows an embodiment of the invention where only half of the columns in the image frame are stored during the first pass, and the other half are stored during a second pass of the capturing process.

FIG. 5 shows an embodiment of the invention based on a Frame Transfer CCD for capture. Storage is implemented as interline CCD.

FIG. 6 shows a first embodiment of the inventive CCD based on Frame Interline Transfer for capture, followed by a single line sequential selective charge transfer, followed by storage based on inverted interline CCD.

### DETAILED DESCRIPTION OF EMBODIMENTS

### Embodiments of the Invention

### First Embodiment

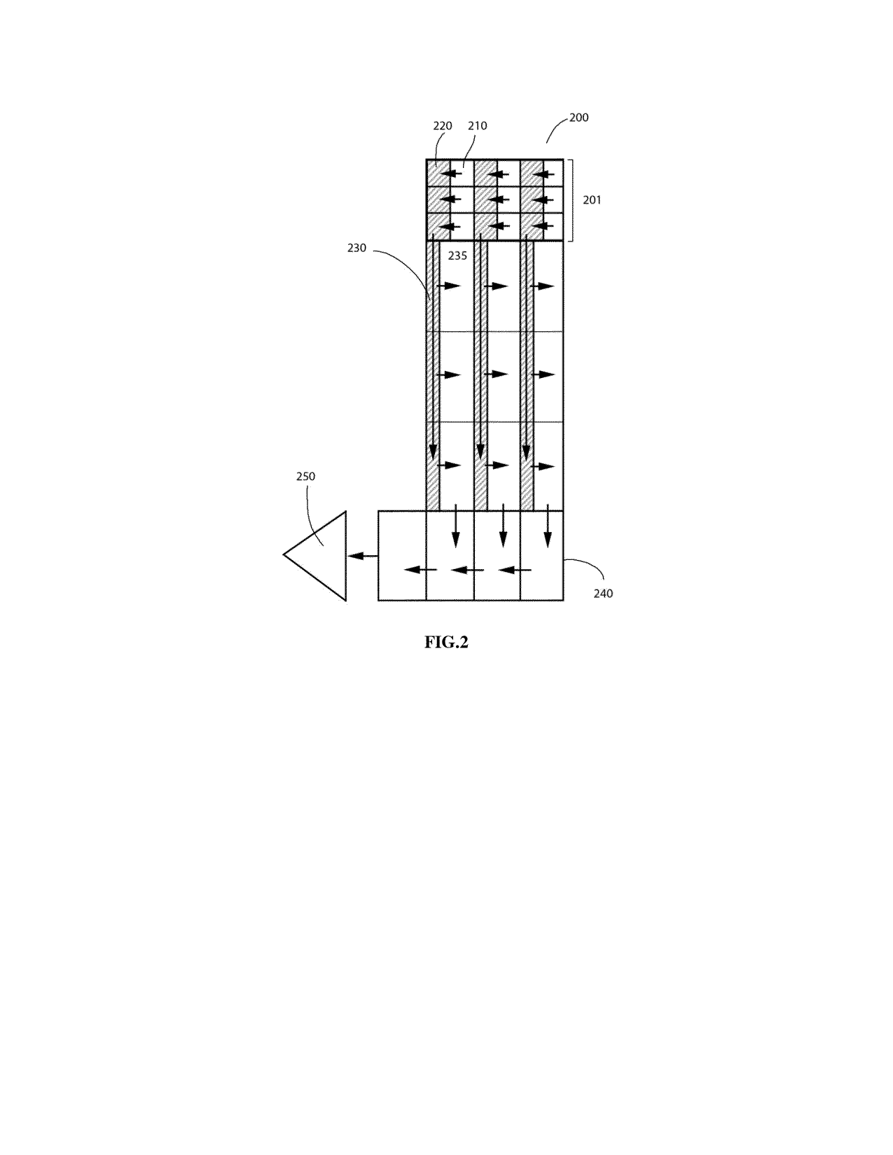

The first embodiment of this invention is based on modifications made to the prior art Frame Interline Transfer CCD described above. Referring to FIG. 2, the basic structure and functionality of the first embodiment 200 is shown. The image capturing frame 201 consists of two types of pixels: Light sensitive pixels (photodiodes) 210, and shielded pixels 220. Shielded pixels have the same charge holding capacity as the photodiodes. Shielded pixels are arranged into columns that will be called vertical shift registers. Immediately below the image capturing frame 201 there is a shielded storage frame comprising the same number of pixels as in 201. The structure of said frame is conceptually a duplicate of 201, only photodiodes are replaced with pixels capable of storing larger amounts of charge. Those pixels are called complementary pixels. Typically, a way to increase storage capacity of a pixel is by making the pixel bigger. One of the complementary pixels is represented as 235. The complementary pixels are used to store a copy of the captured image, which can be of improved quality because of the increased storage capacity. The complementary pixels are arranged in columns forming complementary vertical shift registers. One such register starts with pixel 235. Interleaved between those registers there is another plurality of vertical shift registers represented as long striped boxes 230. These registers are called the striped vertical shift registers of the storage frame, and they correspond to the vertical shift registers of the image frame 201. Each pixel in them has substantially the charge holding capacity of the photodiodes. Immediately below the storage frame there is a row of pixels 240 forming a horizontal shift register. It contains the same number of pixels as the complementary pixels in one row of the storage frame. Immediately to the left of it there is a mechanism used for readout, ending with a signal amplifier 250.

Before image capture is started, all pixels are reset to zero, i.e. they are discharged to hold zero charge. The functioning of the first embodiment can be presented by first considering the three main steps that are repeated iteratively.

In the first step charges created in all photodiodes are transferred individually to the shielded pixels, each photodiode transferring charge to the pixel immediately to the left of it, as represented by arrows. For example, the charge in 210 is transferred to 220.

The second and third steps are equivalent to an Interline Transfer CCD operating in reverse. During the second step, charges in the vertical shift registers of 201 are all at the same time shifted down to the striped registers in the storage frame, as represented by arrows. For one example, the left register starting with 220 is shifted down to the striped register starting with 230. In the third step, charges are transferred simultaneously from the striped vertical shift registers to the complementary vertical shift registers immediately to the right, for example 230 to 235. This is indicated by right arrows. This third step is performing addition of the just moved charges to the charges already stored in the complementary vertical shift registers. It is similar to binning in prior art. The goal of this operation is accumulation of charges in the big complementary pixels of the storage frame, for example 235. During all three steps the photodiodes are collecting light, converting photons to charges uninterruptedly.

Steps 1-3 are repeated iteratively in order to accumulate large amounts of charge in the big complementary storage pixels, for example 235. These charges represent a higher dynamic range version of the captured image. The effect is as if the photodiodes had the large charge holding capacity of the storage pixels. For example, over time photodiode 210 generates large amount of charge, which ends up stored in pixel 235. This is equivalent to an imaginary photodiode of the charge capacity of 235. The whole process results in a high dynamic range image captured with photodiodes of small charge capacity.

The above process terminates after a predefined number of iterations that can be selected by the user. The number of iterations is related to the exposure time. Assuming storage pixels, like 235, have N times larger capacity than photodiodes, it would be possible to increase effective exposure by a factor of N, and increase dynamic range N times. In order to do that, steps 1-3 are repeated N times or more during N times longer exposure time.

In the last readout phase, the process is the same as in the prior art Frame Interline Transfer CCD 100. Charges stored in the vertical shift registers of the storage frame are transferred from the storage frame down to the horizontal shift register 240, one line at a time. After each line transfer, a read out of the horizontal shift register 240 is performed: 240 is repeatedly shifted to the left, one pixel at a time, and after each shift, the leftmost pixel charge is converted to voltage and then processed for output by the amplifier 250. This process continues until all stored pixels are read out through the amplifier.

The reader should have in mind that in the current description the number of pixels in device 200 in FIG. 2 is made small for the purpose of illustrating the idea. In typical implementations the number of pixels is on the order of millions. This will be assumed for all other figures.

### Second Embodiment

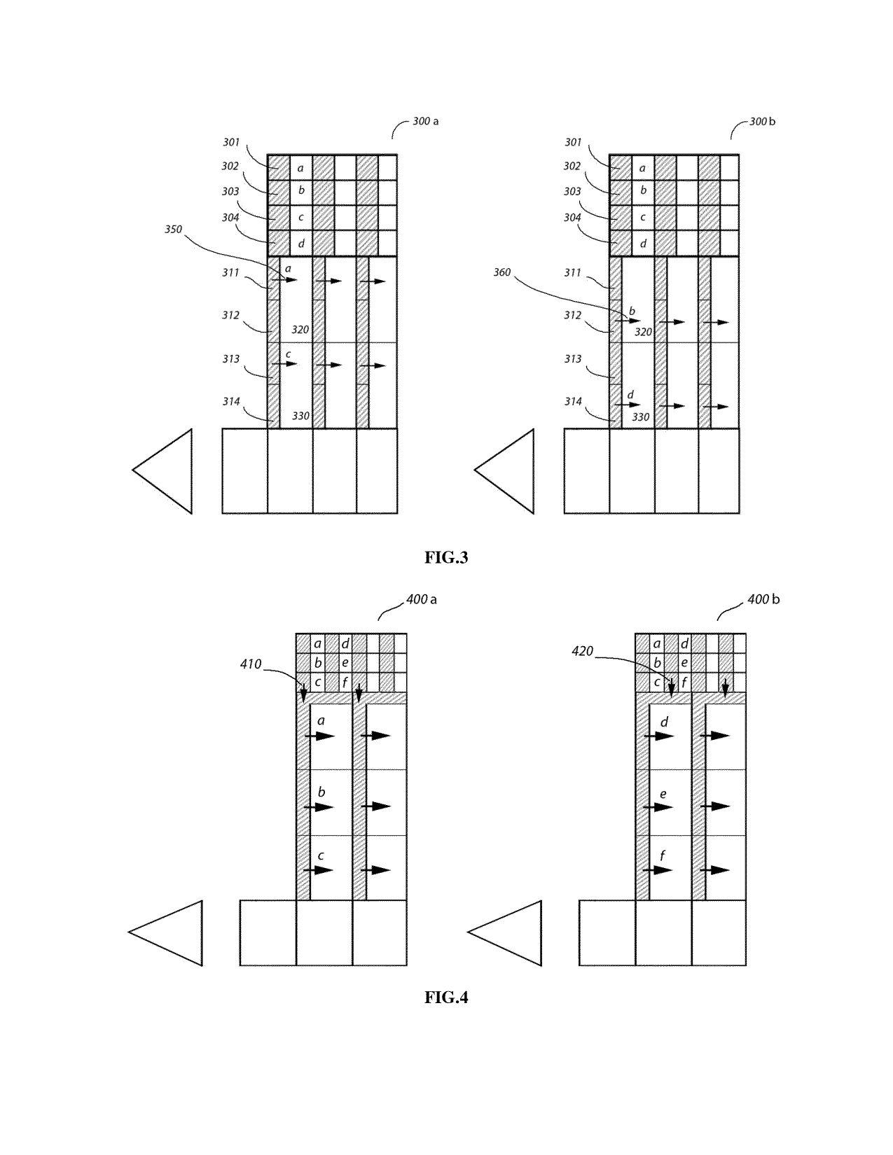

Referring to FIG. 3, the second embodiment of this invention is a CCD represented in two different phases of operation, 300a and 300b. This CCD is useful when the observed object changes slowly. The structure of this CCD is the same as in the first embodiment, except for the shielded storage frame, in which the complementary registers and the transfer of charges is implemented differently. The way in which the transfer of charges is realized in the shielded storage frame of this CCD allows that with a storage frame of the same size as in FIG. 2, two times higher dynamic range is achieved compared to FIG. 2. This is accomplished essentially by making the complementary storage registers two times bigger and running the whole process two times, as will be described next.

Before image capturing is started, all pixels are reset to zero. The functioning of the second embodiment can be presented considering three main steps.

In the first step charges created in all photodiodes are transferred individually to the shielded pixels, each photodiode transferring charge to the pixel immediately to the left of it. For example, the charge a is transferred to 301. During the second step, the charges in the vertical shift registers of the image frame are all at the same time shifted down to the striped registers in the storage frame. For one example, the charges in 301, 302, 303, 304 are shifted to 311, 312, 313, 314.

The third step is performed in two different ways, 3a and 3b. The pixels in the striped vertical shift registers are grouped in vertical pairs, each pair comprising odd numbered pixel on top of even numbered pixel. Each pair has one complementary pixel to the right. For example 311 and 312 have complementary pixel 320. Looking at 300a, in step 3a, charges are transferred simultaneously from the odd numbered pixels in the striped vertical shift registers to the complementary storage registers, as indicated by right arrows. For example charge a is transferred from 311 to 320 as indicated by arrow 350. This third step is performing addition of the just moved charges to the charges already stored in the complementary registers. Then all pixels in the striped vertical registers are reset to zero.

This process of steps 1, 2, 3a is repeated a predefined number of times. The goal of this operation is accumulation of charges in the complementary registers. Then the charges from the complementary vertical shift registers are transferred to the readout register and to the amplifier as in the previous embodiment and prior art. During all three steps, the photodiodes are collecting light, converting photons to charges uninterruptedly.

Looking at 300b, step 3b is performing conceptually the same operations as in step 3a, only this time transferring charge from the remaining (even numbered) pixels of the striped vertical shift registers to the complementary registers. For example, 360 represents transferring of charge b from 312 to 320.

In the particular embodiment of FIG. 3, at the end of the whole process the image will be assembled by interleaving the images resulting from 3a and 3b. Since complementary pixels are two times bigger compared to the first embodiment, the total exposure could be doubled for each of 3a and 3b, doubling the dynamic range of the final image. The total exposure time is quadrupoled. This embodiment is useful for improving the dynamic range in applications where exposure time is not a significant factor.

A plurality of different versions of this CCD design can be constructed by modifying the process so that the pixels comprising the original image are read out in N phases.

This is done by assigning a complementary pixel to each group of N consecutive pixels in the striped vertical shift register, and repeating step 3 N times. As a result the dynamic range is increased N times.

### Third Embodiment

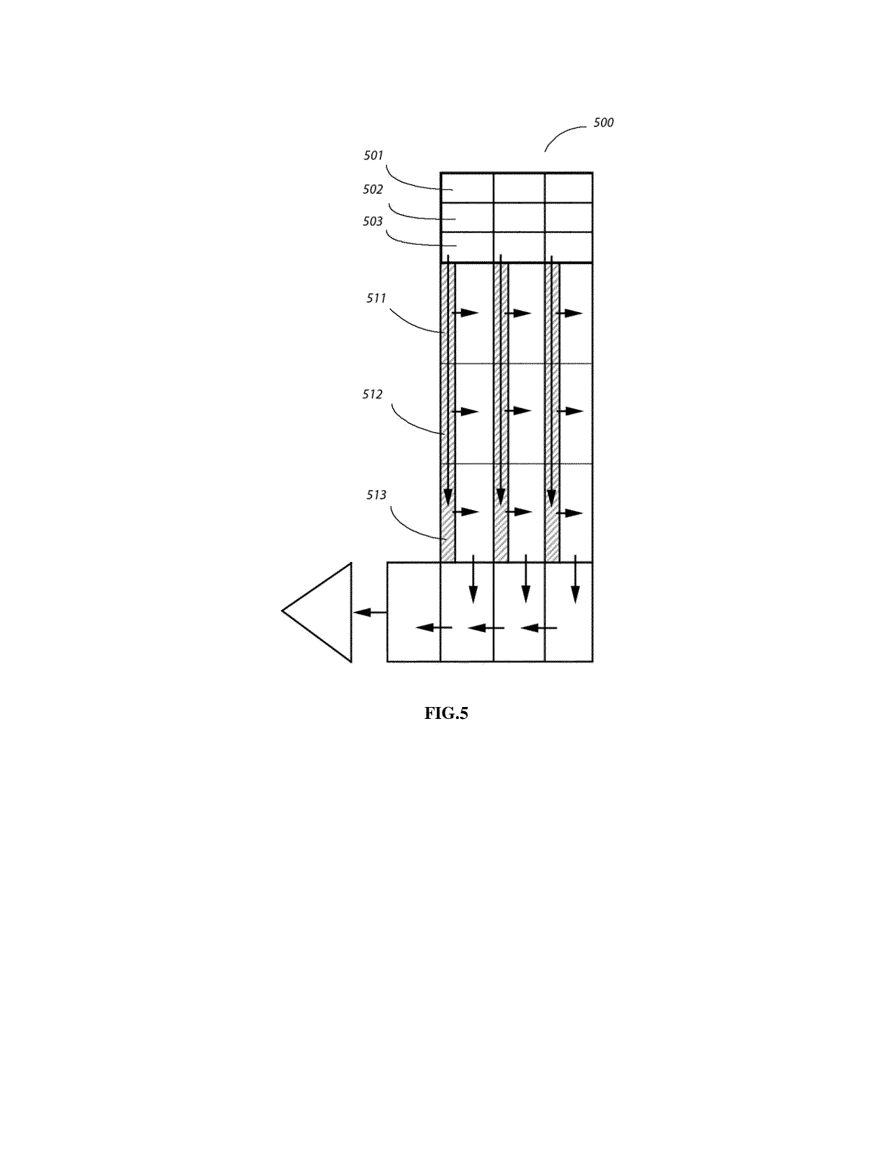

This embodiment is useful when the observed object changes slow. Referring to FIG. 4, the third embodiment of this invention is a CCD represented in two different phases of operation, 400a and 400b. The structure of this CCD is the same as in the first embodiment, except for the larger size of the complementary registers, and the implementation of the transfer of charges from the shielded vertical registers of the image frame to the striped vertical registers of the storage frame. The way the transfer of charges from the image frame to the storage frame is realized in this CCD allows that with a storage frame of the same size as in FIG. 2, twice as high dynamic range is achieved compared to the first embodiment in FIG. 2.

Before image capturing is started, all pixels are reset to zero. The functioning of the third embodiment can be presented considering three main steps.

In the first step charges created in all photodiodes are transferred individually to the shielded pixels, each photodiode transferring charge to the pixel immediately to the left of it. The second step is performed in two different ways, 2a and 2b. There are two groups of shielded vertical shift registers in the image frame. In FIG. 4, the first group is represented by the vertical register that contains pixels a, b, c and the second group is represented by the vertical register that contains pixels d, e, f. The vertical shift registers of the two groups are interleaved in the image frame. Looking at 400a, in step 2a, charges from all shielded vertical registers of the first group are shifted down simultaneously to the striped vertical shift registers of the storage frame, as indicated by down arrows 410. In the third step, charges are transferred simultaneously from the striped vertical shift registers to the complementary vertical shift registers immediately to the right, as indicated by right arrows. This third step performs pixel addition exactly as in the first embodiment.

This process of steps 1, 2a, 3 is repeated a predefined number of times. The goal of this operation is accumulation of charges in the complementary registers. Then the charges from the complementary vertical shift registers are transferred to the readout register and to the amplifier as in the previous embodiments and prior art. During all three steps, the photodiodes are collecting light, converting photons to charges uninterruptedly.

Looking at 400b, step 2b is performing conceptually the same operations as step 2a, only this time shifting charge only from the remaining second group of shielded vertical shift registers in the image frame to the striped vertical shift registers of the storage frame. One of those vertical shifts is indicated as 420.

In the particular embodiment of FIG. 4, at the end of the whole process the image will be assembled by interleaving the images resulting from both paths 1,2a,3 and 1, 2b, 3. Since complementary pixels have double the size of those in the first embodiment, the result is doubling the dynamic range of the final image. Just as in embodiment 2, this embodiment is useful for improving the dynamic range in applications where exposure time is not a significant factor.

The second and third embodiments are given as a way of example of a great number of similar embodiments. Different versions of this CCD design may be constructed simply by modifying the process so that the pixels comprising the original image are grouped into N groups and read out in N phases. As a result the dynamic range is increased N times.

### Fourth Embodiment

The fourth embodiment of this invention works best when the observed object is not changing fast. These are the cases when a frame transfer CCD is adequate for capturing a frame without blur. Referring to FIG. 5, the basic structure and functionality of the fourth embodiment 500 is shown. The image capturing frame consists of light sensitive pixels represented as the rows starting with 501, 502, and 503. Pixels 501, 502, 503 represent a vertical shift register in the image frame. Immediately below the image capturing frame there is a shielded storage frame. It has a structure of interline CCD and it is used as inverted interline CCD: The storage frame of this embodiment is exactly the same as the storage frame in FIG. 2 and comprises of two types of shielded pixels, striped and complimentary, arranged in vertical shift registers. The number of pixels in each one of them is the same as the number of the photodiodes in the vertical shift registers of the image frame. The storage frame is represented as the rows starting with striped pixels 511, 512, and 513. Together pixels 511, 512, 513 represent a striped vertical shift register in the storage frame. Each striped pixel has the charge holding capacity of the photodiodes. To each striped register corresponds a complementary register with the same number of pixels but with each complementary pixel having N times bigger charge holding capacity. Immediately below the storage frame there is a row of pixels forming a horizontal shift register. It contains the same number of pixels as the complementary pixels in one row of the storage frame. Immediately to the left of it there is a mechanism used for readout identical to all of previous embodiments and prior art.

The functioning of this embodiment can be presented by two main steps that are repeated iteratively. In the first step charges created in all photodiodes are shifted down as indicated by the arrows in FIG. 5. For example, charges in photodiode pixels 501, 502, 503 are shifted down to striped vertical register consisting of the pixels 511, 512 and 513.

The second step is conceptually similar to the inverse of a related step in an interline CCD: In the second step, the charges are transferred simultaneously from the striped vertical shift registers to the complementary vertical shift registers immediately to the right, indicated by right arrows. This second step is also performing addition of the just moved charges to the charges already stored in the complementary vertical shift registers. The goal of this operation is accumulation of charges in the big complementary pixels of the storage frame. Before each iteration of those two steps there must be idle time so the photodiodes can collect light. Photodiodes are collecting light, converting photons to charges uninterruptedly. Step 1 has to be performed significantly faster than the waiting time in order to avoid blur.

Steps 1 and 2 are repeated iteratively in order to accumulate large amounts of charge in the big complementary storage pixels. These charges represent a higher dynamic range version of the captured image. The effect is as if the photodiodes had the large charge holding capacity of the complementary storage pixels. The whole process results in a high dynamic range image captured with photodiodes of small charge capacity.

The above process terminates after a predefined number of iterations that can be selected by the user. The number of iterations is related to the exposure time. Assuming complementary storage pixels, have N times larger capacity than photodiodes, it would be possible to increase effective exposure by a factor of N, and increase dynamic range N times. In order to do that, steps 1-2 are repeated N times or more during N times longer exposure time. In the last readout phase, the process is the same as in the prior art Frame Interline Transfer CCD 100.

### Fifth Embodiment

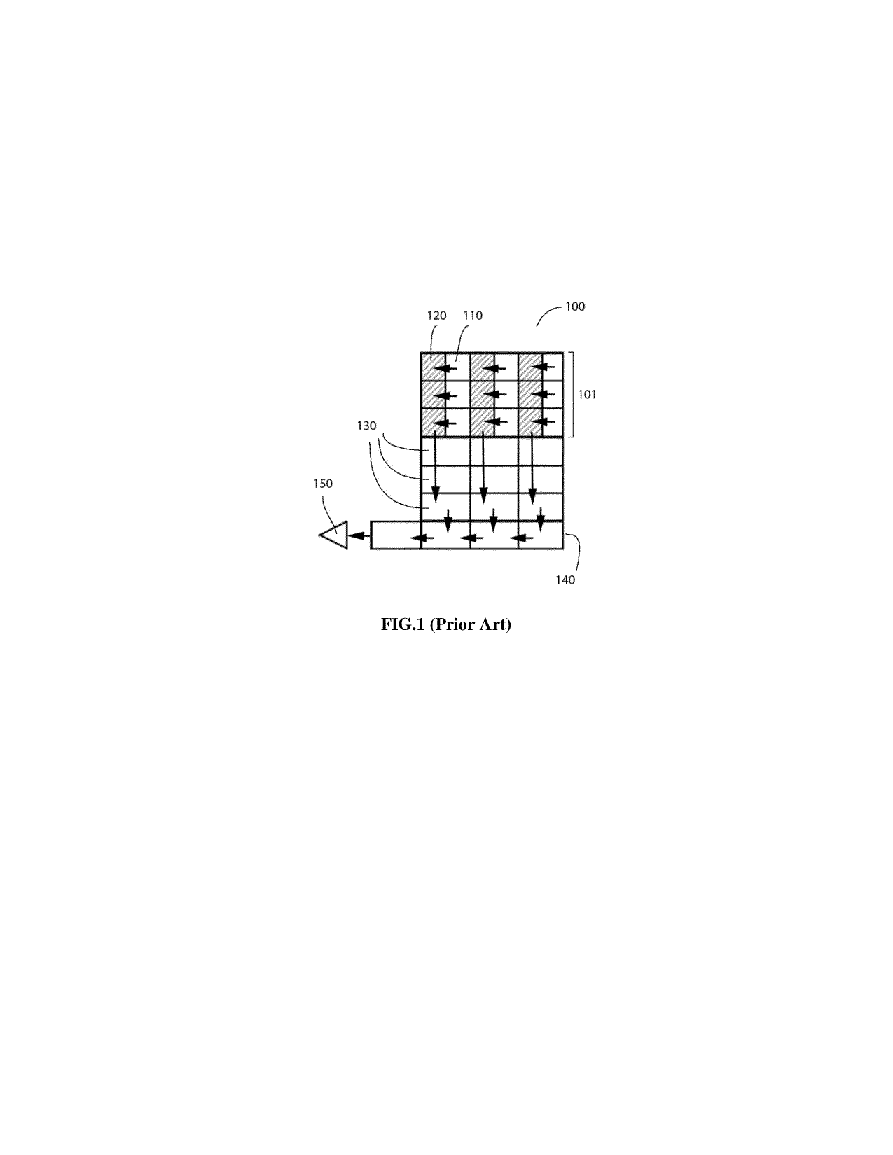

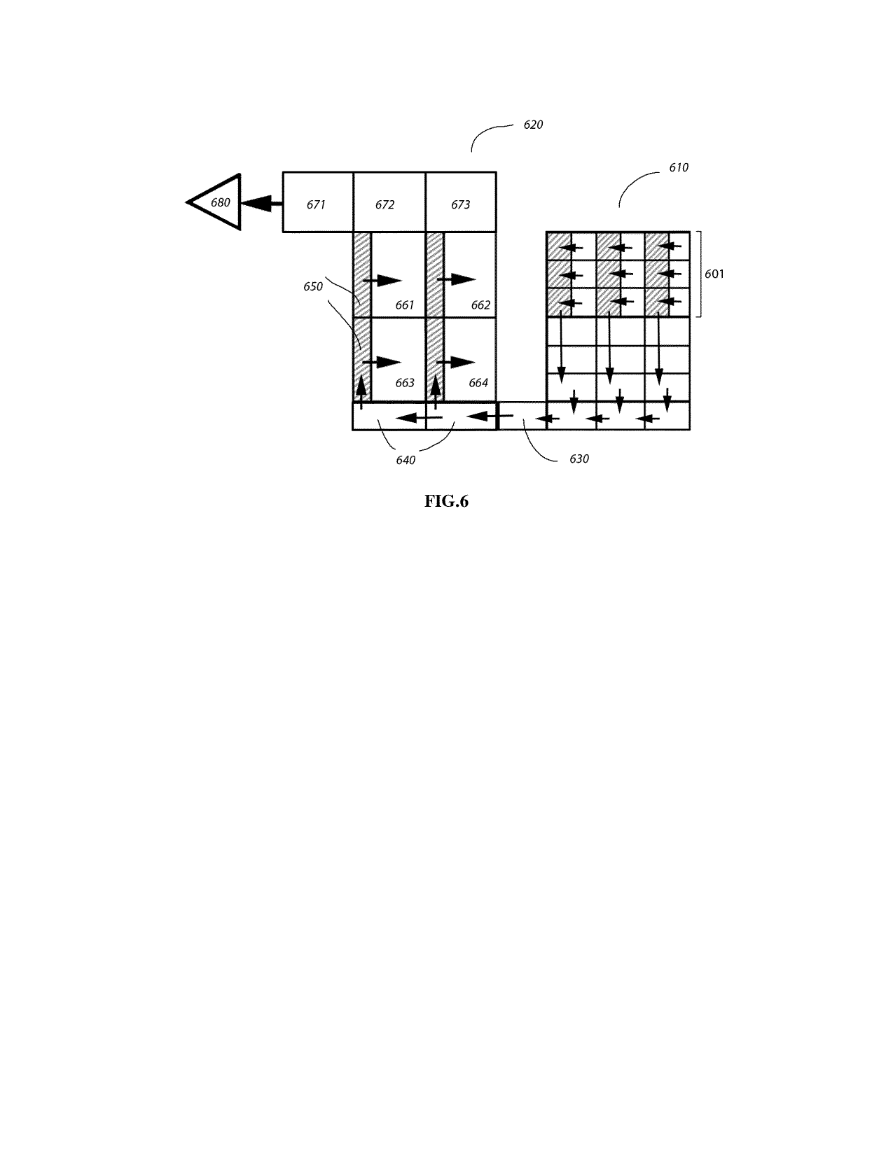

Referring to FIG. 6, the fifth embodiment of this invention is based on two CCDs 610 and 620, and an appropriately arranged charge transfer mechanism between them. 610 is the same as the prior art Frame Interline Transfer CCD 100 of FIG. 1, and it functions in the same way. The output of 610 is a sequence of charges that represent a readout of the image captured in the image frame 601, and are sent consecutively to pixel 630. This whole process provides a stream of individual charges to the second CCD 620.

The second CCD 620 is shielded from light and comprises horizontal shift register 640, striped vertical shift registers, and complementary storage registers comprising pixels 661, 662, 663, 664 that have large charge storage capacity. The storage capacity of each complementary pixel is N times larger than that of a photodiode in 601.

Functioning of 620 will be described in 3 steps. In step one, charges from 630 are taken into the horizontal shift register 640 as they become available, and are shifted to the left one pixel at a time. Shifting of charges by one pixel is performed a number of times equal to the size of the horizontal shift register 640. For example, in 620 the shifting to the left is performed twice. In the second step charges from 640 are shifted vertically to the striped vertical shift registers, where they fill one horizontal line. In this process all charges in the striped vertical shift registers are shifted up. Step 1 and 2 are repeated a number of times equal to the size of the striped vertical shift register in 620, at each iteration filling one more line. In 620 the number of iterations is 2. In step 3 charges from all pixels in the striped vertical shift registers are transferred to their complementary pixels to the right, as indicated by right arrows. These charges are added to the charges in the complementary registers.

Assuming the complementary storage pixels in 620 are N times bigger in charge capacity than the photodiodes in 610, the above process needs to be repeated N times. The result is accumulation of charges in the complementary pixels, which charges are substantially N times bigger than the corresponding charges accumulated in the photodiodes. As in the previous embodiments, the image constructed in this way has N times higher dynamic range and lower noise. This is achieved with N times longer exposure.

In the last readout phase, the process is the same as in prior art Interline Transfer CCDs, only shift is up instead of down because the output is implemented on top of the storage frame. Charges stored in the complementary registers are shifted up to the horizontal shift register 672, 673, one line at a time. After each line transfer, a read out of the horizontal shift register is performed: It is repeatedly shifted to the left, one pixel at a time, and after each shift, the leftmost pixel charge in 671 is converted to voltage and then processed for output by the amplifier 6. This process continues until all pixels stored in the complementary registers are read out through the amplifier.

In order to add greater flexibility to this embodiment, a resetting gate is implemented in 630. Also, the two horizontal shift registers, the one to the left of 630 and the one to the right of 630, are clocked independently. With this modification, the user may choose which charges to pass through the gate, and which charges to remove from the chain. In order for a charge to pass, the two horizontal registers have to be shifted synchronously, and no resetting signal is applied to 630. The two horizontal shift registers act as one. Alternatively, in order to remove a charge, only the horizontal register that is to the right of 630 is shifted, while the horizontal register to the left is stopped. Then 630 is reset to zero.

The above improved embodiment is capable of transferring any part of the captured image to the complementary pixels, thus implementing windowing functionality. The user can select part of the image, in real time, and accumulate a high dynamic range version of it in the complementary pixels. With consecutive capture of different parts, the user can reconstruct the whole image. This also includes the possibility of interleaved capture as in the previous embodiments 2 and 3.

In another variation of the fifth embodiment, the horizontal shift register to the left of 630 contains M pixels. Here M is the total number of pixels in the maximum size window that is to be read out of the image captured in 601. This simplifies the first step, which now fills the horizontal shift register only once. A line of complementary pixels of a storage capacity, which is N times larger than the storage capacity of the photodiodes is located adjacent to the horizontal shift register. Each pixel in the horizontal shift register is complemented by a complementary pixel. With this design step 2 is transferring charges from the horizontal shift register to the line of complementary pixels. Performing step 1 and then step 2 accomplishes one complete transfer of the window of interest from the image frame 601. Repeating N complete transfers accomplishes the high dynamic range image capture of this embodiment. In the end, readout is performed simply by using the line of complementary pixels as a horizontal shift register in the place of 671, 672, 673.

This and all other embodiments may be implemented on a single silicon chip using standard semiconductor processing techniques. Because of the size of the long line of pixels, for this embodiment it is important to use the surface area of the chip efficiently. The lines of pixels implementing the horizontal shift registers do not have to be straight. By bending the double line of pixels multiple times, a very dense curve in the plane can be implemented. The 2D area on the chip is covered very densely in this embodiment.

Just as in the previous embodiments, image capture and output in 610 does not have to be done with interline CCD. Any CCD architecture, like frame transfer CCD or full frame CCD can be used if the object is changing slowly enough that there is no blur. The simplest embodiment in the case of static objects would be to replace 610 with a full frame CCD. After exposure, readout of the CCD is performed in a conventional manner, one line at a time. The pixel charges of each line are transferred to the horizontal shift register that is to the right of 630, and one of the versions of the process of embodiment 5 is performed. A requirement is that exposure time before readout is much longer than readout time, or that a shutter is used and closed during readout. This requirement is conventional in photography.

Considering all embodiments of this invention, it should be clear that different combinations between all five embodiments with different CCD architectures like full frame, frame transfer and interline are possible. Listing them all would be trivial work of combining those possibilities.

What is claimed is:

1. An imaging system comprising:
an array of photon-to-electron charge generating cells,
wherein each charge generating cell can store charge up to a first charge maximum,
wherein the cells collectively generate charge representative of the optical data as conveyed by the photons;
an array of charge storage cells,
wherein the charge storage cell can store charge up to a second charge maximum that is at least two times the first charge maximum,
wherein each charge storage cell is exclusively associated with one photon-to-electron charge generating cell so that no other charge storage cell is associated with that particular photon-to-electron charge generating cell;
charge transfer;
wherein charge is transferred to the charge storage cells from the photon-to-electron charge generating cells, and the charge transfer substantially
extracts the full charge from each photon-to-electron charge generating cell,
preserves full charge amount during transfer, and
adds the transferred charge to the charge content in the charge storage cell;
and
a read out;
wherein charge is substantially converted to electrical signal, and the content of charge storage cells is discharged.

2. The system of claim 1 wherein charge is generated and transferred in an iterative process.

3. The system of claim 2 wherein the iterative process is terminated after a number of iterations determined by the user.

4. The system of claim 1 wherein
charge transfer is performed based on a pre-set timing setting
a consecutive read out of all charge storage cells is performed after the last charge transfer.

5. The system of claim 4, wherein charge transfer and read out of charges from even rows is followed by charge transfer and read out from odd rows.

6. The system of claim 4, wherein charge transfer and read out of charges from even columns is followed by charge transfer and read out from odd columns.

7. The system of claim 4, wherein charge transfer followed by read out is performed consecutively from each of N exclusive groups of photon-to-electron charge generating cells.

8. An imaging system implemented on a single chip comprising:
a modified Frame Interline Transfer CCD
wherein the Frame Interline Transfer CCD storage frame is replaced with a second Interline Transfer CCD
wherein the second Interline Transfer CCD accumulates pixel charges into storage pixels instead of direct output of pixel charges to an amplifier for readout,
wherein the accumulated charges are read out from the storage frame in a conventional fashion using a horizontal shift register and amplifier.

9. The imaging system of claim 8
wherein the second Interline Transfer CCD is operated to accumulate charges into the complementary pixels of the storage frame,
wherein the complementary pixels have storage capacity of at least two times the storage capacity of the light sensitive pixels of the CCD.

10. An imaging system implemented on a single semiconductor chip comprising:
a pair of CCDs with the first CCD having light sensitive pixels,
a horizontal shift register capable of consecutively transferring pixel charges from the first CCD to the second CCD,
the second CCD capable of accumulating said pixel charges in storage pixels, each storage pixel having charge-holding capacity of at least two times the charge-holding capacity of the corresponding light-sensitive pixels in the first CCD.

11. The imaging system of claim 10, where the first CCD is an Interline Transfer CCD.

12. The imaging system of claim 10, where the second CCD is an Interline Transfer CCD is operated to accumulate incoming pixel charges into its storage pixels.

13. The imaging system of claim 12, wherein readout of the second CCD is performed after the end of the accumulation phase in a conventional fashion, using a horizontal shift register.

14. The imaging system of claim 10, clocked by external signals to repeatedly transfer charges a given number of times from the first CCD to the second CCD, the charges from each pixel in the first CCD transferred to a corresponding location in the second CCD and accumulated in that location.

15. The imaging system of claim 10, wherein
the horizontal shift register is split into two parts that are clocked independently;
further comprising a resetting gate between the two parts, said resetting gate passing or not passing charges according to control signal; wherein
the transfer of pixel charges from the first CCD to the second CCD is controlled by a computer.

16. The imaging system of claim 10, where the second CCD is implemented on the same semiconductor chip as two linear CCDs, A and B, parallel to each other and having the same number of pixels
wherein the charge is repeatedly transferred from individual pixels in linear CCD A to corresponding pixels in CCD B
wherein transferred charges are accumulated in each pixel in CCD B,
wherein readout of CCD B is performed after the end of the accumulation phase, using it as a horizontal shift register.
